(19) United States
(12) Patent Application Publication
(10) Pub. No.: US 2009/0250633 A1
(43) Pub. Date: Oct. 8, 2009

(54) RADIATION IMAGE CONVERSION PANEL AND MANUFACTURING METHOD THEREOF

(75) Inventors: Shinichi Okamura, Tokyo (JP); Takafumi Yanagita, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/718,199

(22) PCT Filed: Oct. 24, 2005
(86) PCT No.: PCT/JP2005/019485

§ 371 Date: Apr. 27, 2007

(30) Foreign Application Priority Data
Nov. 4, 2004 (JP) 2004-320326

(51) Int. Cl. G01T 1/00; G21K 4/00

(52) U.S. Cl. 250/484.4

(57) ABSTRACT

An objective is to provide a high quality radiation image conversion panel and a manufacturing method thereof in which strength and heat resistance of an undercoat resin layer, and no cracks are generated in a stimulable phosphor layer. Disclosed is a radiation image conversion panel comprising a support and provided thereon, a stimulable phosphor layer, wherein a crosslinked undercoat resin layer that is formed between the support and the stimulable phosphor layer has a chemical bonding intensity ratio of NCO group/methyl group of 0.2-2.0.

### TECHNICAL FIELD

The present invention relates to a radiation image conversion panel comprising a stimulable phosphor, and a manufacturing method thereof.

### BACKGROUND

Radiation images such as X-ray images are employed in a number of fields, such as for medical diagnoses. In order to obtain the X-ray images, the X-ray, which has passed through an object, is exposed to a phosphor layer (also called a fluorescent screen) to produce visible light, and subsequently a silver halide photosensitive photographic material (hereinafter referred to simply as photosensitive material) is exposed to this visible light similarly to taking a conventional picture and the resulting photosensitive material is subjected to photographic processing to prepare a visible silver image. Thus, this so-called radiographic system is widely utilized.

In recent years, however, a new method has been proposed in which images are directly captured from a phosphor layer instead of the image forming method employing photosensitive materials comprising silver halides. The foregoing method comprises a process of rendering a phosphor to absorb the radiation which has passed through an object, subsequently a process of exciting the resulting phosphor employing light or heat energy so that radiation energy, which has been stored by said phosphor through the above-described absorption, is emitted as fluorescence, and a process of forming images while inspecting the resulting fluorescence.

Specifically, the method refers to a radiation image conversion method utilizing a stimulable phosphor described, for example, in U.S. Pat. No. 3,859,527 and Japanese Patent O.P.I. Publication No. 55-12144. This method utilizes a radiation image conversion panel comprising a stimulable phosphor. In more detail, radiation, which has passed through an object, is incident to a stimulable phosphor layer of the radiation image conversion panel and radiation energy corresponding to transmitted radiation intensity of each portion of the object is stored. Thereafter, the resulting stimulable phosphor is sequentially subjected to stimulation, employing electromagnetic waves (stimulating light), such as visible light, and infrared rays, so that radiation energy stored in the stimulable phosphor is released as stimulated luminescence. The resulting signals, depending on variation of light intensity, are subjected, for example, to photoelectric conversion to obtain electrical signals. The resulting signals are employed to reproduce visible images on recording materials such as photographic materials or on image display apparatuses such as a CRT and so forth.

Compared to radiography in which conventional radiographic photographic films and intensifying screens are employed in combination, the foregoing reproducing method of radiation image recording exhibits advantages such that it is possible to obtain radiation images with ample information, while utilizing substantially reduced radiation exposure. Radiation image conversion panels, which employ these stimulable phosphors, store radiation image information and subsequently release stored energy after being scanned with stimulation light. As a result, after such scanning, it is possible to store radiation images, and repeatedly use the radiation image conversion panels. Namely, in conventional radiography, radiographic photographic films are consumed for every image capture. Contrary to this, in the radiation image conversion method, it is more advantageous from the viewpoint of resource conservation as well as economic efficiency, since it is possible to repeatedly use the same radiation image conversion panel. Further, in recent years, in analysis of diagnostic images, a radiation image conversion panel with higher sharpness is still being demanded. As a means to enhance sharpness, a trial has been made in which for example, the shape of a stimulable phosphor itself is controlled to enhance sensitivity as well as sharpness.

One method in such trails includes, for example, a method in which a stimulable phosphor layer comprised of minute pseudo-columnar blocks, described in Japanese Patent O.P.I. Publication No. 61-142497, is employed which is formed by accumulating a stimulable phosphor onto a support having a fine uneven pattern.

Further, proposed methods include a method to use a radiation image conversion panel having a stimulable phosphor layer, in which, as described in Japanese Patent O.P.I. Publication No. 61-142500, cracks between columnar blocks, which are prepared by accumulating a stimulable phosphor on a support having a fine pattern, are subjected to a shock treatment so that the aforesaid cracks are allowed to grow and further, a method to use a radiation image conversion panel in which a stimulable phosphor layer formed on a support is subjected to formation of cracks on the surface side to be pseudo-columnar (refer to Patent Document 1, for example), and further, a method in which a stimulable phosphor layer having voids is formed on a support, employing vacuum evaporation, and subsequently voids are allowed to grow by a thermal treatment so that cracks are provided (refer to Patent Document 2, for example).

Further proposed is a radiation image conversion panel having a stimulable phosphor layer in which thin and long columnar crystals, having a definite slope with respect to the normal direction of a support, are formed on the foregoing support, employing a vapor phase growth method (refer to Patent Document 3, for example).

A radiation image conversion panel has recently been proposed in which alkali halide, such as CsBr, is incorporated as a host and Eu is used as an activator. Particularly, by employing Eu as an activator, it has become possible to achieve enhancement of X-ray conversion efficiency, which has been considered to be difficult.

When an aluminum plate is used as a support, the support is corroded with time in a radiation image conversion panel comprising a stimulable phosphor layer provided on the support, and image quality of a radiation image tend to be deteriorated. Compared with this, it is proposed that an undercoat layer is formed between the stimulable phosphor layer and the support in order to inhibit corrosion of the aluminum plate. However, when the stimulable phosphor layer is formed on the undercoat layer via the above-described vapor phase growth method, there is a problem such that cracking of the stimulable phosphor layer is generated with insufficient heat resistance of the undercoat layer.

(Patent Document 1) Japanese Patent O.P.I. Publication 62-39737

(Patent Document 2) Japanese Patent O.P.I. Publication 62-110200

(Patent Document 3) Japanese Patent O.P.I. Publication 2-58000

### DISCLOSURE OF THE INVENTION

The present invention was made on the basis of the above-described situation. It is an object of the present invention to provide a high quality radiation image conversion panel and a manufacturing method thereof in which strength and heat resistance of an undercoat resin layer, and no cracks are generated in a stimulable phosphor layer.

The above object of the present invention is accomplished by the following structures.

(Structure 1) A radiation image conversion panel comprising a support and provided thereon, a stimulable phosphor layer, wherein a crosslinked undercoat resin layer that is formed between the support and the stimulable phosphor layer has a chemical bonding intensity ratio of NCO group/methyl group of 0.2-2.0.

(Structure 2) The radiation image conversion panel of Structure 1, wherein a crosslinking agent is a compound having at least two NCO groups in a molecule.

(Structure 3) The radiation image conversion panel of Structure 1, wherein a resin contained in the undrercoat resin layer has a number average molecular weight Mn of less than 80,000.

(Structure 4) The radiation image conversion panel of any one of Structures 1-4, wherein the stimulable phosphor layer comprises a stimulable phosphor represented by the following Formula (1).

M₁X·aM₂X′·bM₃X″:eA Formula (1)

where M₁ is at least one alkali metal atom selected from the group consisting of Li, Na, K, Rb and Cs; M₂ is at least one divalent metal atom selected from the group consisting of Be, Mg, Ca, Sr, Ba, Zn, Cd, Cu and Ni; M₃ is at least one trivalent metal atom selected from the group consisting of Sc, Y, La, Ce, Pr, Nd, Pm, Sm, Eu, Gd, Tb, Dy, Ho, Er, Tm, Yb, Lu, Al, Ga and In; X, X′ and X″ are each a halogen atom selected from the group consisting of F, Cl, Br and I; A is a metal atom selected from the group consisting of Eu, Tb, In, Ce, Tm, Dy, Pr, Ho, Nd, Yb, Er, Gd, Lu, Sm, Y, Tl, Na, Ag, Cu and Mg; a, b and e are each 0≦a≦0.5, 0≦b≦0.5 and 0≦e≦0.2.

(Structure 5) The stimulable phosphor layer in the radiation image conversion panel of any one of Structures 1-4, being formed via a vapor growth method (referred to also as a vapor deposition method) so as to have a thickness of 50 μm-1 mm.

### BRIEF DESCRIPTION OF THE DRAWINGS

FIG. 1(a) and FIG. 1(b) each are a schematic diagram showing an example of shapes of columnar crystals formed on a support.

FIG. 2 is a schematic diagram showing an example of the mode of forming a stimulable phosphor layer on a support via vacuum evaporation.

FIG. 3 is a schematic diagram showing an example of configuration of a reading apparatus and a radiation image conversion panel of the present invention.

FIG. 4 is a schematic diagram showing an example of a method of forming a stimulable phosphor layer stimulable on a support via vacuum evaporation.

### DESCRIPTION OF THE PREFERRED EMBODIMENTS

Next, the present invention will be described in detail.

Employed as supports used for the radiation image conversion panel of the present invention are various types of glass, polymers and metals. Preferable examples thereof include plate glass such as quartz, boro-silicate glass or chemically tempered glass; plastic film such as cellulose acetate film, polyester film, polyethylene terephthalate film, polyethylene naphthalate film, polyamide film, polyimide film, triacetate film or polycarbonate film; a metal sheet made of aluminum, iron or copper; and a metal sheet having a coated layer made of a metal oxide thereof.

Materials usable for the undercoat resin layer of the present invention are not specifically limited, but examples thereof include polyvinyl alcohol, polyvinyl butyral, polyvinyl formal, polycarbonate, polyester, polyethylene terephthalate, polyethylene, nylon, acrylic acid or acrylic acid ester (including methacrylic acid or methacrylic acid ester), vinyl esters, vinyl ketones, styrenes, diolefins, acrylamides (including methacrylamides), vinyl chlorides (including vinylidene chlorides), nitrocellulose, acetylcellulose and a cellulose derivative such as diacetylcellulose, silicone resin, polyurethane resin, polyamide resin, various synthetic rubber based resins, phenol resin, epoxy resin, urea resin, melamine resin and phenoxy resin. However, hydrophobic resins such as polyester resin, polyurethane resin and so forth are preferable in view of adhesion between a support as well as a stimulable phosphor layer, and corrosion resistance of the support. In addition, it is preferable that the resin contained in the undercoat layer of the present invention has a number average molecular weight Mn of less than 80,000. In the case of the number average molecular weight Mn of at least 80,000, image quality of the radiation image conversion panel tends to be deteriorated, since thickness unevenness of the undercoat resin layer becomes large when coating the undercoat resin layer.

The undercoat resin layer preferably has a thickness of 0.1-100 μm.

An undercoat resin layer is obtained via a drying process after coating an undercoat resin layer coating solution onto a support. The coating method is not specifically limited, but coating is allowed to be conducted employing commonly known coaters such as a doctor blade, a roll coater, a knife coater, for example, and also a spin coater.

Examples of the crosslinking agent usable in the present invention include multifunctional isocyanate and its derivative; melamine and its derivative; amino resin and its derivative; and so forth, but a compound having at least two NCO groups in a molecule is preferable. Examples of the compound having at least two NCO groups in a molecule include 1-methylbenzene-2,4,6-triisocyanate, 1,3,5-trimethylbenzene-2,4,6-triisocyanate, diphenylmethane-2,4,4′-triisocyanate, triphenylmethane-4,4′,4″-triisocyanate, bis(isocyanatetolyl)phenylmethane, dimethylene disiocyanate, tetramethylene diisocyanate, hexamethylene diisocyanate, 2,2-dimethylpentane diisocyanate, 2,2,4-trimethylpentane diisocyanate, decane isocyanate, 1,3-phenylene diisocyanate, 1-methylbenzene-2,4-disiocyanate, 1,3-dimethylbenzene-2,6-diisocyanate, naphthalene-1,4-diisocyanate, 1,1′-naphthyl-2,2′-diisocyanate, biphenyl-2,4′-diisocyanate, diphenylmethane-4,4′-diisocyanate, 2,2′-dimethyldiphenylmethane-4,4′-diisocyanate, dicyclohexylmethane-4,4′-diisocyanate, tolylenediisocyanate, 1-5-naphthylenediisocyanate, xylylene diisocyanate, tetramethylene xylylenediisocyanate, and so forth.

The used amount of the crosslinking agent depends on characteristics of an intended radiation image conversion panel, kinds of materials employed for a support and a stimulable phosphor layer, kinds of resins employed for an undercoat resin layer, but it is preferably added at a content of at most 50% by weight, based on the undercoat resin, and more preferably added at a content of 5-30% by weight. In the case of the content of less than 5% by weight, toughness of the undercoat resin layer is lowered (brittle) since a crosslink density is too high, whereby cracking is generated in the undercoat resin layer. On the other hand, in the case of the content exceeding 30% by weight, heat resistance and strength each are insufficient.

In the present invention, heat treatment is conducted at 40-150° C. for 1-100 hours before a stimulable phosphor layer is coated after coating an undercoat layer on the above-described support, in order to complete reaction of a crosslinking agent and a resin contained in an undercoat resin layer.

The method of measuring a chemical bonding intensity ratio of NCO group/methyl group in the present invention will be described.

An undercoat resin layer coated onto a support is partly sampled to prepare a measurement sample. From a chart obtained via FT-IR measurement of the present measurement sample, the chemical bonding intensity ratio of NCO group/methyl group is defined as peak height of NCO at 2270 cm⁻¹ (amount of energy absorption) divided by peak height of methyl at 2970 cm⁻¹ (amount of energy absorption). When the ratio of the crosslinking agent/the resin contained in the undercoat resin layer is the same value, the higher the chemical bonding intensity ratio of NCO group/methyl group, the larger the amount of remaining unreacted crosslinking agent is, indicating low crosslink density.

A chemical bonding intensity ratio of NCO group/methyl group is preferably 0.2-2.0. When the chemical bonding intensity ratio is too low, the crosslink density becomes too high, so that cracking is generated in the undercoat resin layer since toughness of the undercoat resin layer is lowered (brittle). In the reverse case, when the chemical bonding intensity ratio is too high, heat resistance and strength each become insufficient.

Next, the stimulable phosphor layer will be described.

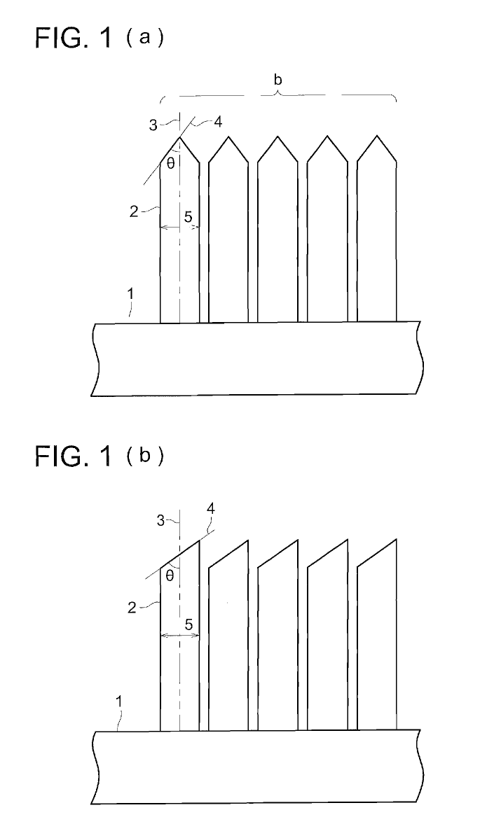

FIG. 1(a) and FIG. 1(b) exemplarily illustrate forms of columnar crystals formed on the support. In FIGS. 1(a) and 1(b), numeral 2 designates a columnar crystal of a stimulable phosphor, which has been formed on support 1 by the vapor-phase deposition process and at the tip of the columnar crystal, symbol θ designates the angle at the intersection of centerline 3 passing through the center in the direction of crystal growth and tangent line 4 to the tip section along the centerline, which is preferably 20-80 degrees, and more preferably 40-80 degrees.

FIG. 1(a) shows columnar crystals having an acute tip, substantially centered on the columnar crystal. FIG. 1(b) shows columnar crystals having an inclined tip, in which the acute site exists across the full surface of the top of the columnar crystals. Further, in the present invention, columnar crystals preferably have an average column diameter of 0.5-50 μm, and more preferably have an average column diameter of 1-50 W.

A haze ratio of stimulable phosphor layer b can be reduced by making the average column diameter of the columnar crystals have a value falling within the range described above, resulting in enhanced sharpness. In the present invention, the diameter of a columnar crystal refers to the diameter of a circle having an area equivalent to the sectional area of the columnar crystal when observed vertical to the support, that is the so-called circular equivalent diameter. The average diameter can be determined by electron-microscopic observation and at least 100 columnar crystals are so observed for the average diameter. The diameter of the columnar crystal is affected by the temperature of the support, the degree of vacuum and the incident angle of the vapor stream, so that columnar crystals of a desired diameter can be prepared by controlling these factors.

The lower temperature of the support tends to render the crystals thinner but excessively low temperature makes it difficult to maintain the columnar form. The temperature of a support is preferably 100-300° C., and more preferably 150-270° C. The incident angle of the vapor stream is preferably 0-5°, and the degree of vacuum is preferably at most 1.3×10⁻¹ Pa.

Next, a vapor deposition process of the present invention will be described in detail. Examples of stimulable phosphors usable in the stimulable phosphor layer, prepared in the vapor deposition process include a phosphor represented by BaSO₄:Aₓ, as described in Japanese Patent O.P.I. Publication No. 48-80487; phosphor represented by MgSO₄:Aₓ, as described in Japanese Patent O.P.I. Publication No. 48-80488; phosphor represented by SrSO₄:Aₓ, as described in Japanese Patent O.P.I. Publication No. 48-80489; phosphors Na₂SO₄, CaSO₄ or BaSO₄ added with at least one of Mn, Dy and Tb, as described in Japanese Patent O.P.I. Publication No. 51-29889; phosphors BeO, LiF, MgSO₄ and CaF₂, as described in Japanese Patent O.P.I. Publication No. 52-30487; phosphor Li₂B₄O₇:Cu, Ag, as described in Japanese Patent O.P.I. Publication No. 53-39277; phosphor Li₂O.(Be₂O₂):Cu, Ag, as Japanese Patent O.P.I. Publication No. 54-47883; and SrS:Ce, Sm, SrS:Eu, Sm, La₂,OS:Eu, Sm and (Zn, Cd)S:Mnₓ, as described in U.S. Pat. No. 3,859,527.

There are also cited ZnS:Cu, Pb phosphor, barrium aluminate phosphors represented by general formula, BaO.xAl₂O₃:Eu, and alkaline earth metal silicate type phosphors represented by general formula, M(II)O.xSiO₂:A, as described in Japanese Patent O.P.I. Publication No. 55-12142.

There are further cited an alkaline earth fluorohalide phosphor represented by Formula (Ba_{1-x-y}MgₓCa_{y})Fₓ:Eu²⁺, as described in Japanese Patent O.P.I. Publication No. 55-12143; phosphor represented by Formula: LnOX:xA, as described in Japanese Patent O.P.I. Publication No. 55-12144; phosphor represented by Formula (Ba₁₋ₓM(II)z)Fₓ:yA, as described in Japanese Patent O.P.I. Publication No. 55-12145; phosphor represented by Formula BaFX:xCe, yA, as described in Japanese Patent O.P.I. Publication No. 55-84389; rare earth element-activated divalent metal fluorohalide phosphor represented by Formula M(II)FX-xA:yLn, as described in Japanese Patent O.P.I. Publication No. 55-160078; phosphor represented by Formula ZnS:A, CdS:A, (Zn, Cd)S:A, X; phosphor represented by Formulas xM₃(PO₄)₂.NX₂:yA and xM₃(PO₄)₂:yA, as described in Japanese Patent O.P.I. Publication No. 59-38278; phosphor represented by Formulas nReX₃.mAX′₂:xEu and nReX₃.mAX′₂:xEu, ySm, as described in Japanese Patent O.P.I. Publication No. 59-155487; alkali halide phosphor represented by Formula of M(I)X.aM(II) X′₂.bM(III) X″₃:cA, as described in Japanese Patent O.P.I. Publication No. 61-72087; and bismuth-activated alkali halide phosphor represented by Formula of M(I)X:xBi, as described in Japanese Patent O.P.I. Publication No. 61-228400. Alkali halide phosphors are specifically preferable since a stimulable phosphor layer composed of columnar crystals are easily prepared via a vacuum evaporation process or a sputtering process.

Next, the stimulable phosphor of the present invention is preferably represented by foregoing Formula (1) will be detailed. In Formula (1), M₁ is at least one alkali metal atom selected from the group consisting of Li, Na, K, Rb and Cs, preferably at least one alkali metal atom selected from Rb and Cs atoms, and more preferably Cs atom. M₂ represents a divalent metal selected from the group consisting of Be, Mg, Ca, Sr, Ba, Zn, Cd, Cu and Ni. Of these, a divalent metal selected from the group consisting of Be, Mg, Ca, Sr, and Ba is preferred. M₃ represents a trivalent metal selected from the group consisting of Sc, Y, La, Ce, Pr, Nd, Pm, Sm, Eu, Gd, Tb, Dy, Ho, Er, Tm, Yb, Lu, Al, Ga. Of these, a trivalent metal selected from the group consisting of Y, Ce, Sm, Eu, Al, Cd, Lu, Ga and In is preferred. A represents at least one metal selected from the group consisting of Eu, Tb, In, Ce, Tm, Dy, Pr, Ho, Nd, Yb, Er, Gd, Lu, Sm, Y, Tl, Na, Ag, Cu and Mg. X, X′ and X″ are each at least one halogen atom selected from the group consisting of F, Cl, Br and I, preferably at least one halogen atom selected from F, Cl and Br, and more preferably at least one halogen atom selected from Br and I in terms of enhancing stimulated emission luminance of a stimulable phosphor. In addition, in Formula (1), “b” is 0≦b≦0.5, but preferably 0≦b≦0.01.

The stimulable phosphor of the present invention represented by Formula (1) can be prepared, for example, in the following manner. As phosphor raw material, at least one compound selected from the following group (a) is used. (a) NaF, NaCl, NaBr, NaI, KF, KCN, KBr, KI, RbF, RBCl, RbBr, RbI, CsF, CsCl, CsBr, and CsI.

At least one compound selected from the following group (b) is used. (b) MgF₂, MgCl₂, MgBr₂, MgI₂, CaF₂, CaCl₂, CaBr₂, CaI₂, SrF₂, SrCl₂, SrBr₂, SrTI₂, BaF₂, BaCl₂, BaBr₂, BaBr₂.2H₂O, BaI₂, ZnF₂, ZnCl₂, ZnBr₂, ZnI₂, CdF₂, CdCl₂, CdBr₂, CdI₉, CuF₂, CuCl₂, CuBr₂, CuI₂, NiF₂, NiCl₂, NiBr₉ and NiI₂.

(c), in foregoing Formula (1), a compound having a metal atom selected from each atom such as Eu, Tb, In, Cs, Ce, Tm, Dy, Pr, Ho, Nd, Yb, Er, Gd, Lu, Sm, Y, Tl, Na, Ag, Cu and Mg is used. In Formula (1), “a” is 0≦a≦0.5 and preferably 0≦a≦0.01; “b” is 0≦b≦0.5, and preferably 0≦b≦0.01; “e” is 0≦e≦0.2, and preferably 0≦e≦0.1.

Phosphor raw materials, which have been selected from the foregoing (a) to (c) so as to have a mixture composition meeting the numerical range, is weighed and mixed sufficiently employing a mortar, ball mill or mixer mill. Further, the resulting phosphor raw material mixture is charged into a heat-resistant vessel such as a silica port, an alumina crucible or a silica crucible and then placed in an electric furnace to be calcined. The calcination temperature preferably is 300-1000° C. The calcination time, depending on a charging amount of raw materials, calcination temperature and the like, preferably is 0.5-6 hours. As a calcination atmosphere is employed a weakly reducible atmosphere such as a nitrogen gas atmosphere containing a small amount of hydrogen gas or a carbon dioxide atmosphere containing carbon monoxide, a nitrogen gas atmosphere, a neutral atmosphere such as an argon gas atmosphere, or a trace amount of oxygen-introduced weakly oxidizing atmosphere. After completion of calcination under the foregoing condition, calcined material is removed from the electric furnace and subjected to pulverization. Thereafter, powdery calcined material may again be charged into a heat resistant vessel and then placed in an electric furnace to be calcined under the foregoing condition to further enhance emission luminance of the phosphor. When the calcined material is allowed to cool from calcination temperature to room temperature, the intended phosphor can be obtained by removing the calcined material from an electric furnace and allowing it to stand in an aerial atmosphere. In this regard, the calcined material may be cooled in the same atmosphere as in the calcination, such as a weakly reducing atmosphere or neutral atmosphere. Alternatively, the calcined material is moved from a heating section to a cooling section within the electric furnace, followed by being rapidly cooled in a weakly reducing atmosphere, neutral atmosphere or weakly oxidizing atmosphere, thereby leading to further enhanced stimulated emission luminance of the phosphor.

It is a feature in the present invention that a stimulable phosphor layer is formed via a vapor growth (deposit) method. Examples of the vapor growth (deposit) method of the stimulable phosphor include an evaporation method, a sputtering method, a CVD method, and an ion plating method.

A vacuum evaporation method as the first method is conducted in such a manner that after placing a support in an evaporator, the inside of the apparatus is evacuated to a vacuum degree of 1.333×10⁻⁴ Pa and subsequently, at least a stimulable phosphor is evaporated with heating by a resistance heating method or an electron-beam method to grow the stimulable phosphor on the support surface to a desired thickness. As a result, a stimulable phosphor layer containing no binder is possible to be formed, provided that the foregoing evaporation process may be divided into plural times to form the stimulable phosphor layer.

In this evaporation process, plural resistance heaters or electron beams may be used at the same time to perform vacuum evaporation, and an intended stimulable phosphor is synthesized on the support, simultaneously forming a stimulable phosphor layer. It is preferable to prepare a radiation image conversion panel of the present invention by forming a protective layer on the opposite side of the support having the stimulable phosphor layer thereon after completion of vacuum evaporation, if desired. In addition, applied may be a procedure in which a support is provided after forming a stimulable phosphor layer on a protective layer. Further, vacuum evaporation may be conducted while cooling or heating a substrate (a support, a protective layer or an intermediate layer) to be deposited thereon, if desired.

After completion of vacuum evaporation, the stimulable phosphor layer may be subjected to a heating treatment. Reactive vacuum evaporation may also be conducted by introducing a gas such as O₂ or H₂ for the foregoing vacuum evaporation.

Sputter deposition as the second method is conducted in such a manner that after setting a support having a protective layer or an intermediate layer thereon in a sputtering apparatus, the inside of the apparatus is evacuated to a vacuum level of 1.333×10⁻⁴ Pa and then inert gas used for sputtering such as Ar and Ne is introduced thereto at a gas pressure of ca. 1.333×10⁻¹ Pa, subsequently, sputtering is carried out with the stimulable phosphor as a target to grow the stimulable phosphor layer on the support so as to have a desired thickness. Similarly to the vacuum evaporation, various kinds of application treatment are usable in the foregoing sputtering process.

There are provided a CVD method as the third method and an ion plating method as the fourth method.

Further, a stimulable phosphor layer in the foregoing vapor phase growth preferably has a growth speed of 0.05-300 μm/min. In the case of a growth speed of less than 0.05 μm/min, productivity of the radiation image conversion panel is low. In addition, in the case of a growth speed exceeding 300 μm/min, it becomes difficult to control the growth speed.

When radiation image conversion panels are prepared by the foregoing vacuum evaporation method, sputtering method and such, the filling density of stimulable phosphor can be increased because of absence of binders, whereby radiation image conversion panels can be preferably obtained in view of sensitivity together with resolution.

The thickness of the foregoing stimulable phosphor depends on the purpose of intended use of a radiation image conversion panel, and kinds of stimulable phosphor, but it is preferably from 50 μm to 1 ml in view of producing effects of the present invention, and more preferably 300-600 μm.

As to a stimulable phosphor layer prepared via the above-described vapor phase growth method, temperature of a support having a stimulable phosphor thereon is preferably set to at least 100° C., more preferably at least 150° C., and still more preferably 150-400° C.

The stimulable phosphor layer in a radiation image conversion panel of the present invention is preferably obtained by forming a stimulable phosphor layer represented by foregoing Formula (1) on a support via vapor phase growth, and it is preferable that the stimulable phosphor forms columnar crystals during layer formation. In order to form a stimulable phosphor composed of columnar crystals via methods such as a vacuum evaporation method, a sputtering method and so forth, compounds (stimulable phosphors) represented by foregoing Formula (1) are utilized, but of these, CsBr based phosphors are specifically preferable.

In the present invention, columnar crystals preferably contain phosphors represented by the following Formula (2) as a principal component.

Formula (2) CsX:AIn Formula (2), X is Br or I, and A is Eu, In, Tb or Ce.

As to a method of forming a phosphor layer a support via a vapor deposition method, vapor or the raw material of a stimulable phosphor is supplied, and the preferable columnar crystals in which the crystals are individually grown in a columnar shape having certain space between them, can be formed by a vapor growth (deposition) method.

In such the case, it is preferable that the shortest distance between the substrate and the crucible is usually set to 10-60 cm for suiting the average range of the stimulable phosphor vapor.

The stimulable phosphor as the evaporation source is charged in the crucible in uniformly molted state or in a shaped state by pressing or hot pressing. A degas treatment is preferably applied on this occasion. Though the evaporation of the stimulable phosphors from the evaporation source is carried out by scanning by an electron beam generated by an electron gun, the evaporation may be performed by another method. It is necessary not always that the evaporation source is the stimulable phosphor, it may be a mixture of the raw materials of the stimulable phosphor. The activator may be added by depositing the mixture of the basic substance and the activator or doping the activator after the deposition of the basic substance. For example, in the case of CsBr is employed as the basic substance, RbBr is solely vapor deposited and Tl is doped as the activator. The doping is possible even when the thickness of the layer is large since the crystals are each independent and the MTF is not lowered because the growing of crystals is difficult to occur. The doping can be performed by thermal diffusion or ion injection into the layer of the basic substance of the phosphor.

The spacing between respective columnar crystals is preferably at most 30 μm, and more preferably at most 5 μm. In the case of the spacing exceeding 30 μm, scattering of laser light in a phosphor layer is increased, resulting in lowered sharpness.

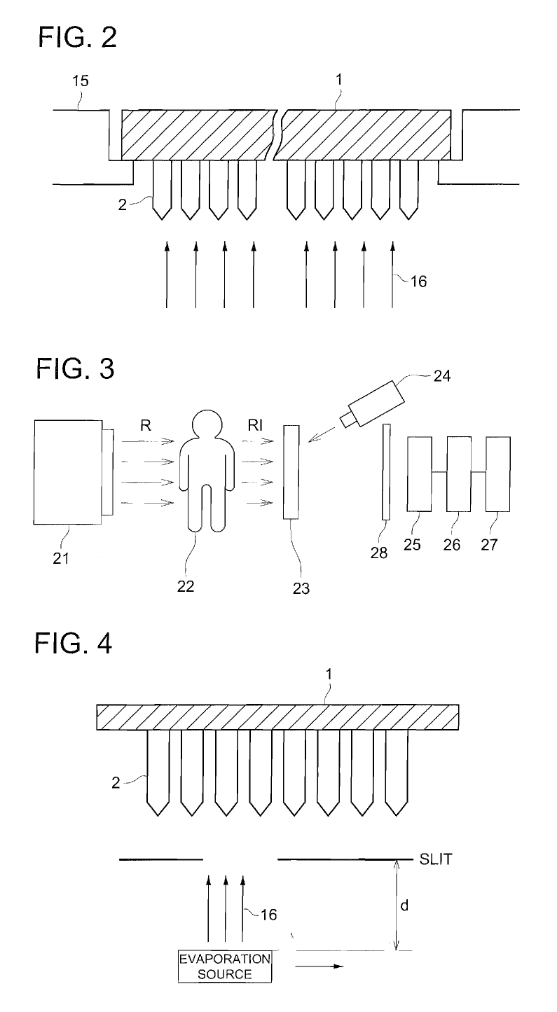

Next, formation of the stimulable phosphor layer of the present invention will be described referring to FIG. 2. FIG. 2 illustrates the mode of forming a stimulable phosphor layer on a support via vacuum evaporation, in which stimulable phosphor vapor stream 16 is introduced at an incident angle of 0-5° to the line normal to the support surface to form columnar crystals on the support.

The stimulable phosphor layer formed on the support contains no binder, leading to superior directionality and enhanced directionality of stimulated emission and stimulated luminescence and enabling formation of a thicker phosphor layer, as compared to radiation image conversion panel having a dispersion-type stimulable phosphor layer, in which a stimulable phosphor is dispersed in a binder. Moreover, reduced scattering of stimulated emission in the stimulable phosphor layer results in enhanced sharpness.

The stimulable phosphor layer formed on the support contains no binder, leading to superior directionality and enhanced directionality of stimulated emission and stimulated luminescence and enabling formation of a thicker phosphor layer, as compared to radiation image conversion panel having a dispersion-type stimulable phosphor layer, in which a stimulable phosphor is dispersed in a binder. Moreover, reduced scattering of stimulated emission in the stimulable phosphor layer results in enhanced sharpness. Further, spacing between columnar crystals may be filled with a filler such as a binder to strengthen the phosphor layer. Furthermore, material exhibiting relatively high light absorbance or high reflectance may be used as filler. The use thereof prevents lateral diffusion of stimulated emission entering into the phosphor layer, in addition to the foregoing strengthening effect. The material exhibiting high reflectance refers to one exhibiting a high reflectance with respect to stimulated emission (500 to 900 nm, specifically 600 to 800 nm), including metals such as aluminum, magnesium, silver and indium, white pigments and colorants ranging green to red.

Reflectance of the stimulable phosphor layer of the present invention is preferably at least 20% in view of obtaining a radiation image conversion panel exhibiting high sensitivity, more preferably at least 30%, and still more preferably at least 40%. In addition, the upper limit of reflectance is 100%. The material exhibiting high reflectance refers to one exhibiting a high reflectance with respect to stimulated emission (500 to 900 nm, specifically 600 to 800 nm), including metals such as aluminum, magnesium, silver and indium, white pigments and colorants ranging green to red.

When a mirror-finishing treatment by which light is reflected on a substrate (aluminum) is conducted (vacuum evaporation, for example) in the present invention, reflectance of a stimulable phosphor layer is measured. The reflectance is measured under the same measuring conditions employing the following measuring apparatus.

Apparatus: HITACHI 1557 type spectrophotometer (Measuring Condition)

Wavelength of measured light: 680 nm

Scanning speed: 120 nm/min

Number of repetition: 10

Response: Automatic setting

White pigments can also reflect stimulated emission. Examples thereof include TiO₂ (anatase type, rutile type), MgO, PbCO₃, Pb(OH), BaSO₄, Al₂O₃, M(II)FX [in which M(II) is at least one of Ba, Sr and Ca, X is at least one of Cl and Br], CaCO₃, ZnO, Sb₂O₃, SiO₂, ZrO₂, lithopone (BaSO₄ ZnS), magnesium silicate, basic lead silisulfate, and aluminum silicate. These pigments exhibit high covering power and have a refractive index high, whereby stimulated luminescence is easily scattered through reflection or refraction, leading to enhanced sensitivity of the radiation image conversion panel.

Examples of material exhibiting high light absorbance include carbon, chromium oxide, nickel oxide, iron oxide, and blue colorants. Of these, carbon absorbs stimulated luminescence.

Colorants may be any organic or inorganic colorants. Examples of organic colorants include Zapon Fastblue 3G (produced by Hoechst A. G.), Estrol Brillblue N-3RL (produced by Sumitomo Chemical Ind. Co. Ltd.), D6CBlue No. 1 (produced by National Aniline Co.), Spirit Blue (produced by HODOGAYA KAGAKU Co., Ltd.), Oilblue No. 603 (produced by Orient Co., Ltd.), Kiton Blue A (produced by Chiba Geigy Co.), Aisen Catironblue GLH (produced by HODOGAYA KAGAKU Co., Ltd.), Lakeblue AFH (produced by KYOWA SANGYO Co., Ltd.), Primocyanine 6GX (produced by INAHATA SANGYO o. Ltd.), Briilacid Green 6BH (produced by HODOGAYA KAGAKU Co., Ltd.), Cyanblue BNRCS (produced by Toyo Ink Co., Ltd.), and Lyonoyl Blue SL (produced by Toyo Ink Co., Ltd.). There are also cited organic metal complex colorants such as Color Index 24411, 23160, 74180, 74200, 22800, 23154, 23155, 24401, 14830, 15050, 15760, 15707, 17941, 74220, 13425, 13361, 13420, 11836, 74140, 74380, 74350 and 74460. Examples of inorganic colorants include ultramarine, cobalt blue, celureun blue, chromium oxide, and TiO₂—ZnO—NiO type pigments.

The stimulable phosphor layer of the present invention may also comprise a protective layer. The stimulable phosphor layer may be provided thereon with a protective layer. The protective layer may be formed by coating a coating composition for the protective layer on the stimulable phosphor layer or the protective layer which was previously prepared may be adhered to the support. Alternatively, a procedure of forming a stimulable phosphor layer on the protective layer which was previously prepared is also applicable. Materials used for the protective layer include those which are usually used for protective layers. Examples thereof include cellulose acetate, nitrocellulose, polymethyl methacrylate, polyvinyl butyral, polyvinyl formal, polycarbonate, polyester, polyethylene terephthalate, polyethylene, polyvinylidene chloride, nylon, polytetrafluoroethylene, polytrifluoroethylene chloride, copolymer of tetrafluoroethylene and hexafluoropropylene, copolymer of vinylidene chloride and vinyl chloride, and copolymer of vinylidene chloride and acrylonitrile. Further, a transparent glass substrate may be used as a support. Furthermore, inorganic material such as SiC, SiO₂, SiN, and Al₂O₃ may be allowed to deposit by means of the vacuum evaporation or sputtering method to form the protective layer. The thickness of a protective layer is preferably 0.1 to 2,000 μm.

FIG. 3 illustrates an example of configuration of a reading apparatus and a radiation image conversion panel of the present invention.

In FIG. 3, numeral 21 represents a radiation generating apparatus, 22 represents an object, 23 represents a radiation image conversion panel having a visible- or infrared-stimulable phosphor layer, 24 represents a stimulated emission source to cause a latent image stored in radiation image conversion panel 23 to be emitted as stimulated luminescence, 25 represents a photoelectric conversion apparatus to detect the stimulated luminescence emitted from radiation image conversion panel 23, 26 represents an image reproduction apparatus to reproduce photoelectric conversion signals detected in photoelectric conversion apparatus 25 in the form of an image, 27 represents a display apparatus to display reproduced images, and 28 represents a filter for reflected light from a light source 24 to allow only light emitted from radiation image conversion panel 23 to pass therethrough. FIG. 3 shows an example of obtaining a transmission-type radiation image, and in cases where object 22 itself radiates radiation rays, radiation generating apparatus 21 may not be particularly required.

An apparatus subsequent to photoelectric conversion apparatus 25 may be any one which is capable of reproducing light information from radiation image conversion panel 23, in any image form.

As shown in FIG. 3, when object 22 is arranged between radiation generation apparatus 21 and radiation image conversion panel 23, and exposed to radiation R, radiation R transmits respective portions of object 22 in accordance with radiation transmittance thereof and the resulting transmission image (also denoted as RI), i.e., an image having different radiation intensities enters radiation image conversion panel 23. The thus entered transmission image RI is absorbed in a stimulable phosphor layer of radiation image conversion panel 23, in which electrons and/or holes are generated in proportion to the dose of the absorbed radiation and accumulated at a trap level of the stimulable phosphor to form a latent image accumulating energies of the radiation transmission image. Subsequently, the latent image is excited with light energy to form an actual image, i.e., the stimulated phosphor layer is irradiated with the light source (24) irradiating visible or infrared light to eject the electrons and/or holes accumulated on the trap level to emit the accumulated energy in the form of stimulated luminescence. The intensity of the emitted luminescence is proportional to the number of accumulated electrons and/or holes, that is, energy of the radiation absorbed in the stimulable phosphor of radiation image conversion panel 23. The thus obtained light signals are converted to electric signals by photoelectric conversion apparatus 25 such as a photomultiplier, which are reproduced as an image in image processor 26, displaying the image in image display apparatus 27. As image processor 26, it is effective to employ one which not only reproduces the electric signals as the image signal but one which can also conduct image processing, computation, memory and storage of the image.

The stimulated luminescence emitted from the stimulable phosphor layer, having a spectral distribution in the lower wavelength region is preferable, based on the reason that the stimulated luminescence emitted from the stimulable phosphor layer is required to be separated from the reflected stimulated emission and photoelectric converters to receive the luminescence emitted from the stimulable phosphor layer, in general, are provided with a sensor having higher sensitivity to light energy of at most 600 nm.

Emission of stimulable phosphors of the present invention falls within the wavelength region of 300-500 nm and the stimulated emission wavelength is 500-900 nm, satisfying the foregoing conditions. Further, along with a recent trend of down-sizing diagnostic apparatuses, semiconductor lasers which exhibit a higher output and are capable of being further down-sized are preferably employed for use in reading images of the radiation image conversion panel. The semiconductor laser has a wavelength of 680 nm and the stimulable phosphor used in the radiation image conversion panel of the present invention exhibits extremely superior sharpness when using a stimulated emission of 680 nm.

Thus, the stimulable phosphors of the present invention emit luminescence having a main peak at 500 nm or less, which is easily separable from the stimulated emission and compatible with spectral sensitivity of the receiver, leading to enhanced light-receiving efficiency and enhanced sensitivity of an image receiving system.

Light sources including the stimulating wavelength for the stimulable phosphor used in radiation image conversion panel 23 are used as stimulated emission source 24. Specifically, the use of laser light simplifies an optical system and leads to enhanced stimulated emission intensity, resulting in preferable performance.

The beam diameter of a laser irradiated onto the stimulable phosphor layer of the present invention is preferably at most 100 nm, and more preferably at most 80 nm.

Examples of the laser include an He—Ne laser, He—Cd laser, Ar ion laser, Kr laser, Ng laser, YAG laser and its second harmonic wave, ruby laser, semiconductor laser, various dye lasers, and metal vapor lasers such as a copper vapor laser. Of these, continuous oscillation lasers such as an He—Ne laser and an Ar ion laser are usually desirable, and pulse-oscillated lasers are also usable by synchronizing the pulse with a scanning time for one pixel of the panel. In cases when employing retarded emission for separation, instead of using filter 28, the use of the pulse-oscillated laser is preferable rather than modulation of the continuous oscillation laser, as described in Japanese Patent O.P.I. Publication No. 59-22046.

Of the various laser light sources described above, semiconductor lasers are specifically preferred in terms of being compact, inexpensive and not requiring a modulator.

Filter 28 cuts reflected stimulated emission and allows the stimulated luminescence emitted from radiation image conversion panel 23 to transmit, which is determined by the combination of the stimulated emission wavelength of a stimulable phosphor contained in radiation image conversion panel 23 and stimulated emission source 24. In the preferred practical combination of a stimulated emission wavelength of 500-900 nm with a stimulated emission wavelength of 300-500 nm, for example, violet to blue glass filters are used, such as C-39, C-40, V-40, V-42 and V-44 (available from TOSHIBA CORP.), 7-54 and 7-59 (available from Corning Co.), BG-1, BG-3, BG-25, BG-37 and BG-38 (available from Spectrofilm Co.). Interference filters are usable by selecting specific filters. Photoelectric conversion apparatus 25 usable in the present invention includes any one capable of converting variation of luminous energy to electric signal, such as a photoelectric tube, a photomultiplier, a photodiode, a phototransistor, a solar cell, and photoconductive elements.

### EXAMPLE

The present invention will be described in detail, referring to examples, but the present invention is not limited thereto. Incidentally, “%” in the examples is “% by weight”, unless otherwise specified.

### Example 1

### Preparation of Radiation Image Conversion Panel

### (Preparation of Undercoat Resin Layer Coating Solutions 1-5)

After mixing polyester resin (VYLON 53SS, produced by Toyobo Co., Ltd.; a number average molecular weight of 17,000) and a multifunctional isocyanate compound (CORONATE 3041, produced by Nippon Polyurethane Industry Co. Ltd.; tolylenediisocyanate containing two NCO groups in a molecule) as a crosslinking agent, this mixture was added into a mixture solvent of a methylethyl ketone-toluene (1:1), and dispersed with a propeller mixer to prepare undercoat resin layer coating solution 1.

Undercoat resin layer coating solutions 2-5 were prepared similarly to preparation of undercoat resin layer coating solution 1, except that a ratio of isocyanate compound to polyester resin was replaced by those described in Table 1.

### (Undercoat Resin Layer Coated Samples 1-5)

The above-described resulting undercoat resin layer coating solutions 1-5 each were coated onto an aluminum support having 10 centimeters square and 500 μm thick so as to give a dry thickness of 2 μm employing a knife coater, and a drying process is subsequently conducted under the conditions described in Table 1 to prepare undercoat resin layer coated samples 1-5.

### (Preparation of Radiation Image Conversion Panels 1-5)

A stimulable phosphor layer containing stimulable phosphor (CsBr:Eu) was formed on each of undercoat resin layer coated samples 1-5 employing an evaporator shown in FIG. 4. In the evaporator of FIG. 4, an aluminum slit was used, and vacuum evaporation was conducted at a distance of 60 cm between the support and the slit, while conveying the support in the direction parallel to the support so as to prepare the stimulable phosphor layer having a thickness of 300 μm.

As for the evaporation, the foregoing undercoat resin layer coated sample was placed in the evaporator, and then, raw material of phosphor as an evaporation source (CsBr:Eu), which was molded in a press was provided in a water-cooled crucible. Then, the inside of the evaporator was once evacuated, and adjusted to a vacuum degree of 0.133 Pa by introducing N₂ gas. Subsequently, evaporation was carried out while maintaining a temperature of the undercoat resin layer coated sample (referred to also as substrate temperature) at about 240° C. The evaporation was completed when the thickness of the stimulable phosphate layer reached 300 μm to obtain radiation image conversion panels 1-5.

### <<Evaluation>>

The following evaluation was conducted employing each of the radiation image conversion panels prepared above. The evaluation results are shown in Table 1.

### (Cracking Evaluation of Undercoat Resin Layer)

Undercoat resin layer samples after coating and a heat treatment were humidified independently at 23° C. and 55% RH, and 23° C. and 20% RH for 3 hours, and subsequently presence or absence of cracks generated on the sample surface was visually observed and evaluated according to the following criteria.

A: No crack is generated.
B: Cracks of at most 2 mm in size are generated.
C: Cracks of at least a few centimeters in size are generated.

### (Cracking Evaluation of Stimulable Phosphor Layer)

The resulting radiation conversion panels were humidified independently at 23° C. and 55% RH, and 23° C. and 20% RH for 3 hours, and subsequently presence or absence of cracks generated on the sample surface was visually observed and evaluated according to the following criteria.

A: No crack is generated.
B: Cracks of at most 2 mm in size are generated.
C: Cracks of at least a few centimeters in size are generated.

TABLE 1

| Radiation | Chemical bonding | Isocyanate compound | | Cracking of undercoat | Cracking of stimulable | | |
|---|---|---|---|---|---|---|---|
| image | intensity ratio | (% by weight), | | resin layer | phosphor layer | | |
| conversion | of NCO group/ | based on | Drying | 23° C., | 23° C., | 23° C., | |
| panel No. | CH₃ group | polyester resin | condition | 55% RH | 55% RH | 20% RH | Remarks |
| 1 | 2.5 | 33 | 150° C., 1 h | C | A | C | Comparative |
| | | | | | | | example |
| 2 | 2.3 | 28 | 150° C., 1 h | A | A | B | Present |
| | | | | | | | invention |
| 3 | 1.9 | 50 | 150° C., 8 h | A | A | B | Present |
| | | | | | | | invention |
| 4 | 0.6 | 7 | 150° C., 1 h | A | A | A | Present |
| | | | | | | | invention |
| 5 | 0.1 | 2 | 150° C., 1 h | C | C | C | Comparative |
| | | | | | | | example |

(*)The value is defined as peak height of NCO at 2270 cm⁻¹ (amount of energy absorption) divided by peak height of methyl at 2970 cm⁻¹ (amount of energy absorption)

As is clear fro Table 1, it is to be understood that radiation image conversion panels exhibit less generation of cracks in any one of the undercoat resin layer and the stimulable phosphor layer.

### POSSIBILITY OF INDUSTRIAL USE

In the present invention, provided can be a high quality radiation image conversion panel and a manufacturing method thereof in which strength and heat resistance of an undercoat resin layer, and no cracks are generated in a stimulable phosphor layer.

What is claimed is:

1. A radiation image conversion panel comprising a support and provided thereon, a stimulable phosphor layer,
wherein a crosslinked undercoat resin layer that is formed between the support and the stimulable phosphor layer has a chemical bonding intensity ratio of NCO group/methyl group of 0.2-2.0.

2. The radiation image conversion panel of claim 1,
wherein a crosslinking agent is a compound having at least two NCO groups in a molecule.

3. The radiation image conversion panel of claim 1,
wherein a resin contained in the undrercoat resin layer has a number average molecular weight Mn of less than 80,000.

4. The radiation image conversion panel of claim 1,
wherein the stimulable phosphor layer comprises a stimulable phosphor represented by the following Formula (1).
M₁X·aM₂X′·bM₃X″:eA Formula (1)
where M₁ is at least one alkali metal atom selected from the group consisting of Li, Na, K, Rb and Cs; M₂ is at least one divalent metal atom selected from the group consisting of Be, Mg, Ca, Sr, Ba, Zn, Cd, Cu and Ni; M₃ is at least one trivalent metal atom selected from the group consisting of Sc, Y, La, Ce, Pr, Nd, Pm, Sm, Eu, Gd, Tb, Dy, Ho, Er, Tm, Yb, Lu, Al, Ga and In; X, X′ and X″ are each a halogen atom selected from the group consisting of F, Cl, Br and I; A is a metal atom selected from the group consisting of Eu, Tb, In, Ce, Tm, Dy, Pr, Ho, Nd, Yb, Er, Gd, Lu, Sm, Y, Tl, Na, Ag, Cu and Mg; a, b and e are each 0≦a≦0.5, 0≦b≦0.5 and 0≦e≦0.2.

5. The stimulable phosphor layer in the radiation image conversion panel of claim 1, being formed via a vapor growth method (referred to also as a vapor deposition method) so as to have a thickness of 50 μm-1 mm.

6. The stimulable phosphor layer in the radiation image conversion panel of claim 2, being formed via a vapor growth method (referred to also as a vapor deposition method) so as to have a thickness of 50 μm-1 mm.

7. The stimulable phosphor layer in the radiation image conversion panel of claim 3, being formed via a vapor growth method (referred to also as a vapor deposition method) so as to have a thickness of 50 μm-1 mm.

8. The stimulable phosphor layer in the radiation image conversion panel of claim 4, being formed via a vapor growth method (referred to also as a vapor deposition method) so as to have a thickness of 50 μm-1 mm.
